(19) United States
(12) Patent Application Publication
(10) Pub. No.: US 2025/0171010 A1
(43) Pub. Date: May 29, 2025

(54) DRIVE FORCE CONTROL SYSTEM FOR ELECTRIC VEHICLE

(71) Applicant: TOYOTA JIDOSHA KABUSHIKI KAISHA, Toyota-shi (JP)

(72) Inventors: Yusuke SUZUKI, Nisshin-shi (JP); Koichi OKUDA, Toyota-shi (JP); Atsushi TABATA, Okazaki-shi (JP)

(73) Assignee: TOYOTA JIDOSHA KABUSHIKI KAISHA, Toyota-shi (JP)

(21) Appl. No.: 18/958,287

(22) Filed: Nov. 25, 2024

(30) Foreign Application Priority Data
Nov. 27, 2023 (JP) 2023-200199

(51) Int. Cl. B60W 20/15; B60W 10/06; B60W 10/08

(52) U.S. Cl. CPC B60W 20/15; B60W 10/06; B60W 10/08

(57) ABSTRACT

A drive force control system for an electric vehicle configured to reduce noises and vibrations during propulsion by controlling a motor serving as a prime mover. A controller of the drive force control system comprises: a vibration determiner that determines whether an operating point of the motor will enter a noise region; and a torque ratio changer that changes a ratio between a torque driving a first wheel and a torque driving a second wheel to deviate the operating point of the motor from the noise region, when the vibration determiner determines that the operating point of the motor will enter the noise region.

### CROSS-REFERENCE TO RELATED APPLICATIONS

The present disclosure claims the benefit of Japanese Patent Application No. 2023-200199 filed on Nov. 27, 2023 with the Japanese Patent Office.

### BACKGROUND

### Field of the Invention

Embodiments of the present disclosure relate to the art of a drive force control system for an electric vehicle having a motor as a prime mover for driving any one of pairs of front wheels and rear wheels, and another prime mover including an engine or a motor for driving the other one of pairs of front wheels and rear wheels.

### Discussion of the Related Art

JP-A-2008-283836 describes an electric vehicle having a first differential mechanism, a second differential mechanism, and an electric motor. The first differential mechanism includes a first motor, a right drive wheel, and a first coupling shaft, and those members are coupled to one another to rotate in a differential manner. The second differential mechanism includes a second motor, a left drive wheel, and a second coupling shaft, and those members are coupled to one another to rotate in a differential manner. A first sun gear is mounted on the first coupling shaft, and a second sun gear is mounted on the second coupling shaft. A pinion gear meshes with the first sun gear and the second sun gear, and an electric motor is connected to the pinion gear. Therefore, in the electric vehicles described in JP-A-2008-283836, the torques generated by the first motor and the second motor are delivered to the right drive wheel and the left drive wheel. A difference between rotational speeds of the right drive wheel and the left drive wheel varies in accordance with rotational speeds of the motors.

JP-A-2011-200036 describes an electric vehicle having a first drive unit connected to one of a left drive wheel and a right drive wheel, and a second drive unit connected to the other drive wheel. A first motor is connected to the first drive unit, and a second motor is connected to the second drive unit. The controller for controlling those motors is configured to control torque of each of the motors so as to generate a target torque to achieve a required torque to propel the vehicle in the normal condition. The controller is further configured to rotate the motor connected to one of the drive wheels at a target rotational speed corresponding to the wheel speed, when a disturbance factor to abruptly change a rotational speed of one of the drive wheels is detected.

As described above, each of the electric vehicles described in JP-A-2008-283836 and JP-A-2011-200036 is provided with the motor connected to the left drive wheel and the motor connected to the right drive wheel. In those electric vehicles, therefore, different torques may be delivered to the left drive wheel and the right drive wheel by altering the output torques of the respective motors. However, an AC motor is usually adopted as the motor serving as a prime mover of the electric vehicle, and the output torque of the AC motor pulsates depending on a rotational angle of the motor. In addition, the torque of the gear arranged in the torque transmission path between the motor and the drive wheels varies according to the rotational angle thereof. Therefore, the torque delivered to the drive wheels also pulsates due to such change in the torque of the gear depending on the rotation angle of the gear. Consequently, abnormal noises and vibrations may be generated during propulsion of the electric vehicle due to mechanical factors of the torque transmission path between the motor and the drive wheels. In addition, the motor is operated in response to a switch signal transmitted at a frequency corresponding to the rotational speed of the motor to the inverter. Therefore, during operation of the motor, abnormal noises and vibrations may be generated due to an electrical factor. Such abnormal noises and vibrations generated by the above-described mechanical and electrical factors may be increased due to resonance of the torque transmission path with the motors.

### SUMMARY

Aspects of embodiments of the present disclosure have been conceived noting the foregoing technical problems, and it is therefore an object of the present disclosure to provide a drive force control system for an electric vehicle configured to reduce noises and vibrations during propulsion by controlling a motor serving as a prime mover.

The drive force control system according to the exemplary embodiment of the present disclosure is applied to an electric vehicle comprising: a motor that drives a first wheel as one of a front wheel and a rear wheel; and another prime mover that drives a second wheel as other one of the front wheel and the rear wheel. In the electric vehicle, a four-wheel drive mode in which the electric vehicle is propelled by the motor and the another prime mover is available. The drive force control system comprises a controller that controls the motor. In order to achieve the above-explained objective, according to the exemplary embodiment of the present disclosure, the controller comprises: a vibration determiner that is configured to determine whether an operating point of the motor governed by an output torque and a speed of the motor will enter a noise region in which noise and vibrations of the motor are amplified during operation of the motor; and a torque ratio changer that is configured to change a torque ratio as a ratio between a torque driving the first wheel and a torque driving the second wheel from a reference torque ratio so as to deviate the operating point of the motor from the noise region, when the vibration determiner determines that the operating point of the motor will enter the noise region.

In a non-limiting embodiment, the controller may further comprise a guard value calculator that calculates an upper limit value and a lower limit value of an amount of change in the torque ratio. Specifically, the guard value calculator may be configured to set the upper limit value and the lower limit value in a case that the reference torque ratio is employed to maintain a performance of the electric vehicle.

In a non-limiting embodiment, the torque ratio changer may be further configured to start changing the torque ratio at an earlier timing when changing the torque ratio significantly.

In a non-limiting embodiment, the torque ratio changer may be further configured to change a torque of the another prime mover with a change in a required driving torque to propel the electric vehicle while maintaining an output torque of the motor to the torque before the operating point of the motor enters the noise region, when the vibration determiner determines that the operating point of the motor will enter the noise region due to a change in the output torque of the motor.

Thus, when the operating point of the motor governed by a speed and an output torque of the motor is expected to enter the noise region where noises and vibrations of the motor being operated are amplified, the ratio between the torque driving the first wheel and the torque driving the second wheel is altered from the reference torque ratio so as to shift the operating point of the motor to outside of the noise region. According to the exemplary embodiment of the present disclosure, therefore, an entrance of the operating point of the motor into the noise region may be prevented while generating the required driving torque to propel the electric vehicle. For this reason, the noses and the vibrations may be reduced during propulsion of the electric vehicle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a powertrain of a four-wheel independent drive electric vehicle to which the control system according to the exemplary embodiment of the present disclosure is applied;

FIG. 2 is a skeleton diagram showing one example of a structure of a rear drive unit;

FIG. 3 is a skeleton diagram showing one example of a structure of a front drive unit;

FIG. 4 is a block diagram showing incident signals to a controller and output signals from the controller;

FIG. 5 is a torque map for determining a required driving torque to propel the electric vehicle;

FIG. 6 is a noise map defining a noise region in which noise and vibration are amplified during operation of the motor;

FIG. 7 is a block diagram showing components of the controller;

FIG. 8 is a flowchart showing one example of a routine executed by the control system according to the exemplary embodiment of the present disclosure;

FIG. 9 is a time chart showing an example of changing a torque ratio in such a manner as to prevent an entrance of an operating point of the motor into a noise region when a speed of the vehicle increases in a situation where the driving torque to propel the vehicle is constant; and

FIG. 10 is a time chart showing an example of changing the torque ratio in such a manner as to prevent an entrance of an operating point of the motor into the noise region when a require driving torque to propel the vehicle is increased.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure which should not limit a scope of the present disclosure.

The control system according to the exemplary embodiment of the present disclosure is applied to an electric vehicle in which one of pairs of front wheels and rear wheels is driven by a motor as a prime mover, and the other pair of front wheels and rear wheels is driven by another prime mover including an engine and a motor. That is, in the vehicle to which the control system according to the exemplary embodiment of the present disclosure is applied, the front wheels and the rear wheels are driven separately by their own dedicated prime movers. In the vehicle, the front wheels may be connected to the front prime mover through a differential mechanism, and the rear wheels may be connected to the rear prime mover through another differential mechanism. In addition, the control system according to the exemplary embodiment of the present disclosure may also be applied to an electric vehicle in which each wheel is provided with a dedicated prime mover respectively. In this case, driving torques and regenerative braking torques of the wheels may be controlled independently.

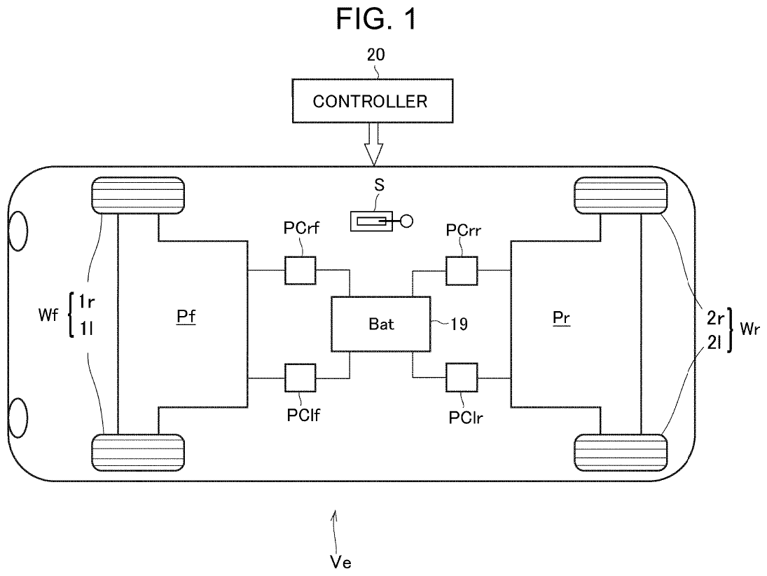

Referring now to FIG. 1, there is shown one example of a structure of a four-wheel independent drive layout vehicle to which the control system according to the exemplary embodiment of the present disclosure is applied. In the vehicle Ve shown in FIG. 1, driving torques and regenerative braking torques of wheels may be controlled independently. That is, all of the wheels are driven separately or independently by their own dedicated prime movers. As schematically illustrated in FIG. 1, the vehicle Ve comprises: a pair of front wheels 1r and 1l (also referred to commonly as the front wheels wr); a pair of rear wheels 2r and 2l (also referred to commonly as the rear wheels wr); a front drive unit Pf serving as a prime mover to drive the front wheels 1r and 1f; and a rear drive unit Pr serving as a prime mover to drive the rear wheels 2r and 2l. Each of the front drive unit Pf and the rear drive unit Pr comprises a motor and a geared reduction mechanism (i.e., a transmission mechanism). In the exemplary embodiment of the present disclosure, the front wheels 1r and 1l and the rear wheels 2r and 2l flexibly serves as first driving wheels and second driving wheels.

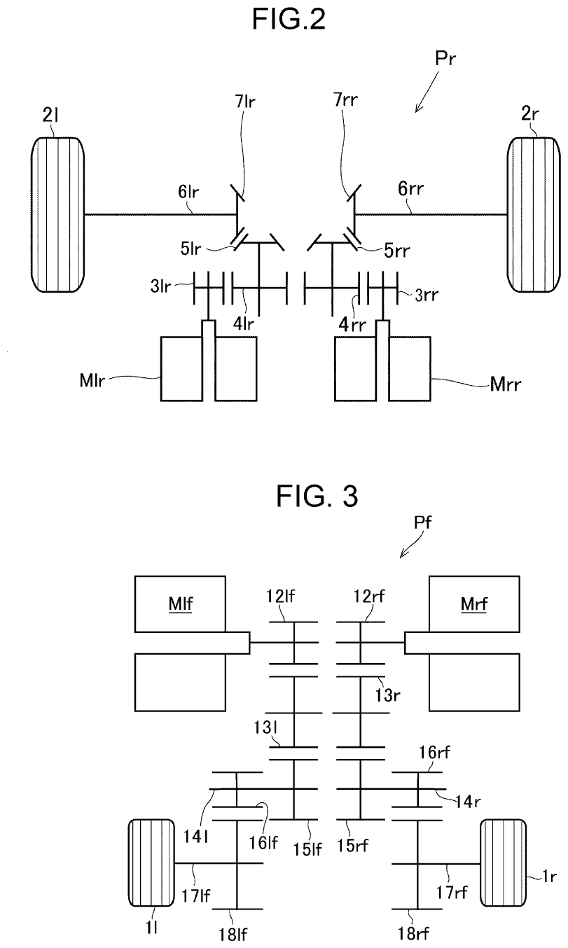

Turning to FIG. 2, there is shown one example of a structure of the rear drive unit Pr. In the rear drive unit Pr, a pair of drive systems are arranged symmetrically in the horizontal direction to control the right rear wheel 2r and the left rear wheel 2l independently.

In the rear drive unit Pr, specifically, a right rear motor Mrr and a left rear motor Mlr are positioned symmetrically in a manner such that rotor shafts of those motors extend in the longitudinal direction of the vehicle Ve respectively. A right drive gear 3rr is mounted on the rotor shaft of the right rear motor Mrr to be meshed with a right counter driven gear 4rr. Likewise, a left drive gear 3lr is mounted on the rotor shaft of the left rear motor Mlr to be meshed with a left counter driven gear 4lr. A diameter of the right counter driven gear 4rr is larger than a diameter of the right drive gear 3rr, and a diameter of the left counter driven gear 4lr is larger than a diameter of the left drive gear 3lr. That is, a pair of the right drive gear 3rr and the right counter driven gear 4rr serves as a speed reduction mechanism, and a pair of the left drive gear 3lr and the left counter driven gear 4lr also serves as a speed reduction mechanism. A right counter drive gear 5rr is arranged coaxially with the right counter driven gear 4rr to be rotated integrally with the right counter driven gear 4rr, and is meshed with a right driven gear 7rr as a bevel gear formed integrally on a right rear driveshaft 6rr connected to the right rear wheel 2r. Likewise, a left counter drive gear 5lr is arranged coaxially with the left counter driven gear 4lr to be rotated integrally with the left counter driven gear 4lr, and is meshed with a left driven gear 7lr as a bevel gear formed integrally on a left rear driveshaft 6lr connected to the left rear wheel 2l. A pair of the right counter drive gear 5rr and the right driven gear 7rr may also serves as a speed reduction mechanism by increasing a diameter of the right driven gear 7rr larger than a diameter of the right counter drive gear 5rr. Likewise, a pair of the left counter drive gear 5lr and the left driven gear 7lr may also serves as a speed reduction mechanism by increasing a diameter of the left driven gear 7lr larger than a diameter of the left counter drive gear 5lr.

Turning to FIG. 3, there is shown one example of a structure of the front drive unit Pf. In the front drive unit Pf, specifically, a right front motor Mrf and a left front motor Mlf are positioned symmetrically in a manner such that rotor shafts of those motors extend in the lateral (i.e., width) direction of the vehicle Ve respectively. A right drive gear 12rf is mounted on the rotor shaft of the right front motor Mrf to be meshed with a right idle gear 13r, and the right idle gear 13r is also meshed with a right counter driven gear 15rf mounted on a right counter shaft 14r extending parallel to a rotational center axis of the right idle gear 13r. Likewise, a left drive gear 12lf is mounted on the rotor shaft of the left front motor Mlf to be meshed with a left idle gear 13l, and the left idle gear 13l is also meshed with a left counter driven gear 15lf mounted on a left counter shaft 14l extending parallel to a rotational center axis of the left idle gear 13l.

A diameter of the right counter driven gear 15rf is larger than a diameter of the right drive gear 12rf mounted on the rotor shaft of the right front motor Mrf, and a diameter of the left counter driven gear 15lf is larger than a diameter of the left drive gear 12lf mounted on the rotor shaft of the left front motor Mlf. That is, a pair of the right drive gear 12rf and the right counter driven gear 15rf serves as a speed reduction mechanism, and a pair of the left drive gear 12lf and the left counter driven gear 15lf also serves as a speed reduction mechanism. A right counter drive gear 16rf is also mounted on the right counter shaft 14r to be meshed with a right driven gear 18rf formed integrally on a right front driveshaft 17rf connected to the right front wheel 1r. Likewise, a left counter drive gear 16lf is also mounted on the left counter shaft 14l to be meshed with a left driven gear 18lf formed integrally on a left front driveshaft 17lf connected to the left front wheel 1l. A diameter of the right driven gear 18rf is larger than a diameter of the right counter drive gear 16rf, and a diameter of the left driven gear 18lf is larger than a diameter of the left counter drive gear 16lf. That is, a pair of the right counter drive gear 16rf and the right driven gear 18rf also serves as a speed reduction mechanism, and a pair of the left counter drive gear 16lf and the left driven gear 18lf also serves as a speed reduction mechanism.

As illustrated in FIG. 1, an electric storage device (referred to as Bat in FIG. 1) 19 as a direct-current power source is electrically connected with the front drive unit Pf and the rear drive unit Pr through power controllers. For example, a secondary battery such as a lithium-ion battery, an all-solid battery or the like may be adopted as the electric storage device 19. Whereas, a permanent magnet synchronous motor is adopted as each of the motors Mrf, Mlf, Mrr, and Mlr. That is, a motor-generator is adopted as each of the motors Mrf, Mlf, Mrr, and Mlr. Specifically, the right front motor Mrf is connected with the electric storage device 19 through a right front power controller PCrf, the left front motor Mlf is connected with the electric storage device 19 through a left front power controller PClf, the right rear motor Mrr is connected with the electric storage device 19 through a right rear power controller PCrr, and the left rear motor Mlr is connected with the electric storage device 19 through a left rear power controller PClr. Each of the power controllers PCrf, PClf, PCrr, and PClr is individually composed mainly of an inverter. Therefore, a direct-current voltage accumulated in the electric storage device 19 is translated into an alternating-current voltage to be supplied to the motors Mrf, Mlf, Mrr, and Mlr, and an alternating-current voltage regenerated by the motors Mrf, Mlf, Mrr, and Mlr is translated into a direct-current voltage to be accumulated in the electric storage device 19. Thus, output torques and regenerative braking torques of the motors Mrf, Mlf, Mrr, and Mlr may be controlled independently or separately. Here, the output torques and the regenerative braking torques of the motors Mrf, Mlf, Mrr, and Mlr may also be controlled by a common power controller as long as the output torques and the regenerative braking torques of those motors can be controlled independently.

Thus, in the vehicle Ve, the output torques of the motors Mrf, Mlf, Mrr, and Mlr may be controlled independently. Accordingly, an operating mode of the vehicle Ve may be selected from a two-wheel drive mode and a four-wheel drive mode. For example, the vehicle Ve may be propelled in the two-wheel drive mode by operating the right rear motor Mrr and the left rear motor Mlr as prime movers while interrupting power supply to the right front motor Mrf and the left front motor Mlf. Whereas, in the four-wheel drive mode, the vehicle Ve is propelled by all of the motors Mrf, Mlf, Mrr, and Mlr. ln this case, a ratio between: the output torques of the front motors Mrf and Mlf; and the output torques of the rear motors Mrr and Mlr, may be altered arbitrarily in line with the driver's preference.

The operating mode is selected to control mainly a driving torque in a desired manner. For example, the four-wheel drive mode may be selected from a truck mode, a drift mode, a manual range mode, and a manual sports mode. Specifically, in the truck mode, driving torques and regenerative braking torques of the motors Mrf, Mlf, Mrr, and Mir are controlled in such a manner as to enhance a turning performance of the vehicle Ve. In the drift mode, torques of the wheels 1r, 1l, 2r, and 2l are controlled separately in such a manner as to reduce an under steering and to optimize tractions of the wheels 1r, 1l, 2r, and 2l thereby enhancing a turning performance and a driving accuracy of the vehicle Ve. ln the manual range mode, a shift range as a relation between a position of an accelerator pedal and a required drive torque is shifted in response to an operation of a shifting device S executed by a driver. ln the manual sports mode, the shift range is also changed in response to the operation of the shifting device S in such a manner that a large driving torque is ensured to a high-speed range so as to enhance the acceleration performance or the power performance.

In order to control the motors Mrf, Mlf, Mrr, and Mlr in accordance with e.g., the selected operating mode, the vehicle Ve is provided with a controller 20. The controller 20 is composed mainly of a microcomputer, and performs a calculation using incident data and program stored in advance, with reference to maps stored in advance. Calculation results are transmitted from the controller 20 to e.g., the motors Mrf, Mlf, Mrr, and Mlr in the form of command signal.

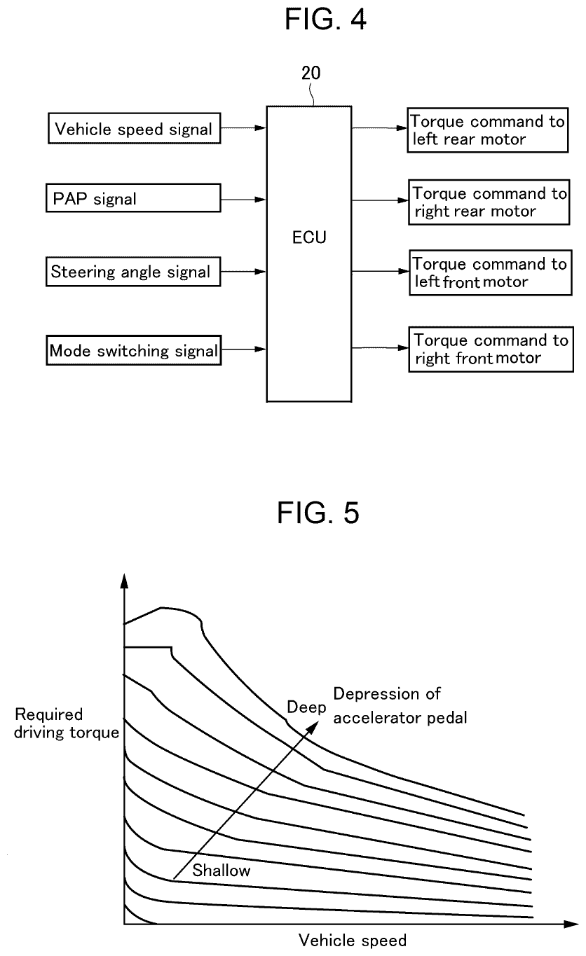

Turning to FIG. 4, there is shown an example of incident signals to the controller 20 and output signals from the controller 20. As shown in FIG. 4, for example, a signal representing a vehicle speed detected by a vehicle speed sensor (not shown), a signal representing a position of the accelerator pedal (referred to as PAP signal in FIG. 4) detected by an acceleration sensor (not shown), a signal representing a steering angle detected by a steering sensor (not shown), a signal representing an operating mode selected by a selector switch (not shown) etc., are transmitted to the controller 20. For example, the controller 20 transmits a control signal of the torque of the left rear motor Mlr driving the left rear wheel 2l, a control signal of the torque of the right rear motor Mrr driving the right rear wheel 2r, a control signal of the torque of the left front motor Mlf driving the left front wheel 1l, a control signal of the torque of the right front motor Mrf driving the right front wheel 1r.

FIG. 5 shows an example of a driving torque map for determining a driving torque required to propel the vehicle Ve (hereinafter referred to as the required driving torque). The map shown in FIG. 5 is stored in the controller 20, and is configured to determine the required driving torque based on a speed of the vehicle Ve and a position of the accelerator pedal. ln FIG. 5, specifically, the horizontal axis represents the speed of the vehicle Ve, the vertical axis represents the required driving torque, and each curve represents positions of the accelerator pedal. The driving torque map may also be configured to vary the required driving torque with respect to a predetermined position of the accelerator pedal in accordance with the selected operating mode. ln addition, dedicated driving torque maps may be prepared for each of the operating modes.

The controller 20 determines the required driving torque with reference to the drive torque map based on a speed of the vehicle Ve and a position of the accelerator pedal. Then, the controller 20 determines a ratio between a torque for driving the pair of front wheels Wf and a torque for driving the pair of rear wheels Wr to achieve the required driving torque to propel the vehicle Ve (hereinafter, also referred to as the torque ratio) based on the selected operating mode, the required driving torque, a road gradient, a steering angle detected by the steering angle sensor etc., and determines target torques of the motors Mrf, Mlf, Mrr and Mlr based on the determined torque ratio. Thereafter, the controller 20 transmits switch signals to the inverters of the power controllers PCrf, PClf, PCrr, and PClr on the basis of rotational speeds of the motors Mrf, Mlf, Mrr and Mlr and the determined required driving torque. Therefore, the motors Mrf, Mlf, Mrr and Mlr generate torques respectively in accordance with the speed of the vehicle Ve, the position of the accelerator pedal, and the selected driving mode.

During propulsion of the vehicle Ve, noises and vibrations are generated due to electric and mechanical factors. For example, noises and vibrations are generated by the electric factors relating to the motors Mrf, Mlf, Mrr and Mlr and the switch signals of the inverters transmitted in accordance with the rotational speed. ln addition, noises and vibrations are generated by the mechanical factors such as a change in engagement condition of e.g., gears arranged between the rear motors Mrr and Mlr and the pair of rear wheels Wr. Such noises and vibrations are amplified by resonance of the motors Mrf, Mlf, Mrr and Mlr with components of the drive unit Pf and Pr.

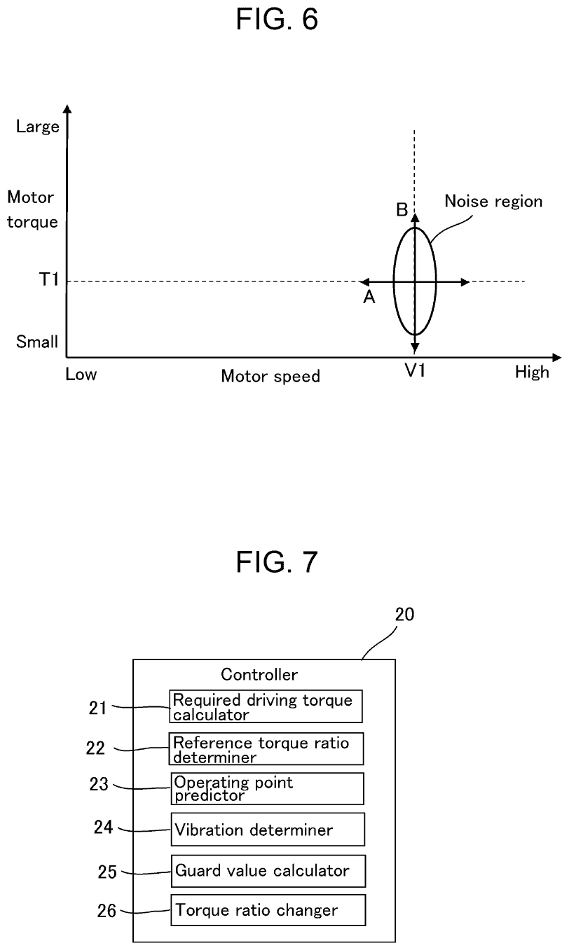

FIG. 6 shows an example of a first noise map determining a first noise region in which noises and vibrations are amplified during operation of the rear motors Mrr and Mlr (hereinafter, also referred to commonly as the rear motor Mr). ln FIG. 6, the horizontal axis represents a speed of the rear motor Mr, and the vertical axis represents a torque of the rear motor Mr to propel the vehicle Ve. The first noise region is governed by structures of the rear motor Mr, the inverter, the rear drive unit Pr and so on, and is determined based on a result of an experimentation or a simulation. As shown in FIG. 2, the gear ratio between the rear motor Mr and the rear wheel Wr is constant, therefore, a speed of the vehicle Ve may also be employed as a parameter of the horizontal axis in FIG. 6. Specifically, the output torque of the rear motor Mr is determined based on the required torque to propel the vehicle Ve and the ratio between the torque for driving the front wheel wf and the torque for driving the rear wheel wr (i.e., the torque ratio). Therefore, by determining the torque ratio, the required torque for propelling the vehicle Ve may also be adopted as a parameter of the vertical axis in FIG. 6. Likewise, a second noise region in which noises and vibrations are amplified during operation of the front motors Mrf and Mlf (hereinafter also commonly referred to as a front motor Mf) is determined by a second noise map similar to FIG. 6.

As described above, the noise regions are governed by the structures of the motors Mrf, Mlf, Mrr, Mlr, the inverters, the drive unit Pf, Pr, and so on. Therefore, the noise region may also be defined based on operations of the motors Mrf or Mlf as a main factor.

For example, an operating point of the rear motor Mr governed by the torque and the speed of the rear motor Mr will enter the first noise region when the speed of the rear motor Mr is reduced in the direction A shown in FIG. 6 in the situation where the rear motor Mr generates a predetermined torque T1. Likewise, the operating point of the rear motor Mr will also enter the first noise region when the torque of the rear motor Mr is increased in the direction B shown in FIG. 6 in the situation where the rear motor Mr is operated at a predetermined speed V1.

The drive force control system according to the present disclosure is configured to alter the aforementioned torque ratio when the operating point of the rear motor Mr is expected to enter the first noise region or when the operating point of the front motor Mf is expected to enter the second noise region. Consequently, the operating point of the rear motor Mr and the operating point of the front motor Mf individually fall outside of the noise regions.

FIG. 7 shows an example of functional components of the controller 20 for controlling the motors Mrf, Mlf, Mrr, and Mlr. As shown in FIG. 7, the controller 20 comprises a required driving torque calculator 21, a reference torque ratio determiner 22, an operating point predictor 23, a vibration determiner 24, a guard value calculator 25, and a torque ratio changer 26.

The required driving torque calculator 21 is configured to calculate the required driving torque for propelling the vehicle Ve based on the signal representing a speed of the vehicle Ve and the signal representing a position of the accelerator pedal transmitted to the controller 20, with reference to the torque map.

The reference torque ratio determiner 22 is configured to determine the reference torque ratio in the same manner as in the conventional art, regardless of whether or not the operating points of the motors fall within the noise regions. Specifically, the reference torque ratio determiner 22 determines the reference torque ratio based on the selected operating mode, the required driving torque for propelling the vehicle Ve, the road gradient, the steering angle, and so on.

The operating point predictor 23 in configured to predict the operating points of the motors Mrf, Mlf, Mrr, and Mlr within a predetermined period of time. To this end, first of all, the operating point predictor 23 predicts an amount of change in the speed of the vehicle Ve within the predetermined period of time provided that the current position of the accelerator pedal is fixed, based on a road gradient detected by e.g., a navigation system. Otherwise, the operating point predictor 23 predicts an amount of change in the required driving torque for maintaining a current speed of the vehicle Ve based on a road gradient detected by e.g., the navigation system. Then, the operating point predictor 23 predicts a rotational speed of the front motor Mf by multiplying a speed calculated by adding the predicted amount of change in the vehicle speed to the current vehicle speed by e.g., the gear ratio of the front drive unit Pf. ln this case, the operating point predictor 23 predicts an output torque of the front motor Mf by multiplying: a torque calculated by adding the predicted amount of change in the required driving torque to the current required driving torque; by the current torque ratio and the gear ratio of the drive unit Pf. As a result, the operating point of the front motor Mf is predicted based on the predicted speed and the output torque. The operating point of the rear motor Mr may also be predicted in the same manner as explained above. The amount of change in the speed of the vehicle Ve within the predetermined period of time may also be predicted based on a current rate of change in the speed of the vehicle Ve. Whereas, the amount of change in the required driving torque within the predetermined period of time may also be predicted based on a rate of change in a position of the accelerator pedal.

The vibration determiner 24 is configured to determine whether the operating point of the rear motor Mr predicted by the operating point predictor 23 will enter the first noise region, and whether the operating point of the front motor Mf also predicted by the operating point predictor 23 will enter the second noise region. As described above, the first noise region and the second noise region are stored in the controller 20.

The drive force control system according to the embodiment of the present disclosure is configured to change the torque ratio from the reference torque ratio when the vibration determiner 24 determines that the operating point of the rear motor Mr will enter the first noise region or when the operating point of the front motor Mf will enter the second noise region. Whereas, when the vehicle Ve is turning or traveling on a rough road such as a rocky road, the reference torque ratio is employed so as to maintain a current performance of the vehicle Ve. In those cases, if the torque ratio is changed or the amount of change in the torque ratio is large, the performance of the vehicle Ve may not be maintained. Therefore, in the case that the reference torque ratio is employed to maintain the performance of the vehicle Ve in the above-described situations, the guard value calculator 25 calculates an upper limit value and a lower limit value of the amount of change in the torque ratio so as to inhibit the change in the torque ratio or to limit the amount of change in the torque ratio based on the driving condition of the vehicle Ve.

The torque ratio changer 26 is configured to change the ratio between the torque for driving the pair of front wheels Wf and the torque for driving the pair of rear wheels Wr (i.e., the torque ratio) so as to prevent an entrance of the operating point of the rear motor Mr into the first noise region or an entrance of the operating point of the front motor Mf into the second noise region. For example, when the vibration determiner 24 determines that the operating point of the rear motor Mr will enter the first noise region, the torque ratio changer 26 changes the torque ratio to a ratio possible to shift the operating point of the rear motor Mr outside of the first noise region. Likewise, when the vibration determiner 24 determines that the operating point of the front motor Mf will enter the second noise region, the torque ratio changer 26 changes the torque ratio to a ratio possible to shift the operating point of the front motor Mf outside of the second noise region.

In those cases, the torque ratio may be changed by increasing the torque driving the pair of front wheels Wf while reducing the torque driving the pair of rear wheels Wr. Instead, the torque ratio may also be changed by increasing the torque driving the pair of rear wheels Wr while reducing the torque driving the pair of front wheels Wf. If the amount of change in the torque ratio is large, the behavior of the vehicle Ve may be changed significantly. Therefore, it is preferable to increase the torque driving one of the pairs of front wheels Wf and the rear wheels Wr while reducing the torque driving the other one of the pairs of the front wheels Wf and the rear wheels Wr in such a manner as to reduce the amount of change in the torque ratio. Given that the upper limit value and the lower limit value of the amount of change in the torque ratio are set by the guard value calculator 25, the torque ratio is changed within the range between the upper limit value and the lower limit value.

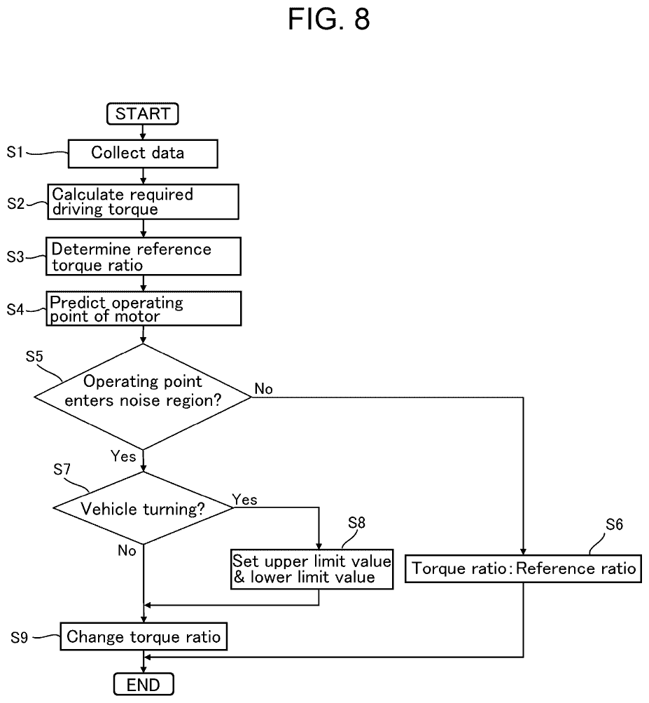

An example of the control executed by the controller 20 will be explained hereinafter with reference to the flowchart shown in FIG. 8. At step S1, data relating to e.g., a position of the accelerator pedal, a speed of the vehicle Ve, a driving mode transmitted to the controller 20 is collected. At step S2, the required driving torque calculator 21 calculates the required driving torque for propelling the vehicle Ve based on the data relating to the position of the accelerator pedal and the speed of the vehicle Ve transmitted to the controller 20, with reference to the torque map stored in the controller 20.

At step S3, the reference torque ratio determiner 22 determines the reference torque ratio based on the required driving torque calculated by the required driving torque calculator 21, and the data relating to the road gradient, the steering angle etc., transmitted to the controller 20.

At step S4, the operating point predictor 23 predicts the operating points of the motors Mrf, Mlf, Mrr, and Mlr within the predetermined period of time. As described above, the operating points of the motors Mrf, Mlf, Mrr, and Mlr may be predicted based on the current speed of the vehicle Ve, the required driving torque, the road gradient etc. Instead, the operating points of the motors Mrf, Mlf, Mrr, and Mlr may also be predicted based on the current speed of the vehicle Ve and the rate of change in the required driving torque.

According to this control example, when the operating point of the rear motor Mr is expected to enter the first noise region or when the operating point of the front motor Mf is expected to enter the second noise region, the torque ratio is changed at the predetermined rate. For this purpose, the predetermined period of time is set to a period in which the operating point of the motor predicted to enter the first noise region or the second noise region when changing the torque ratio at the predetermined rate can be shifted to outside of the first noise region or the second noise region.

At step S5, the vibration determiner 24 determines whether the operating point of the rear motor Mr predicted at step S4 will enter the first noise region, and whether the operating point of the front motor Mf will enter the second noise region. For example, the entrance of the operating point of the rear motor Mr into the first noise region may be determined based on a fact that the current output torque of the rear motor Mr falls within the range between the minimum torque and the maximum torque in the first noise region. Otherwise, the entrance of the operating point of the rear motor Mr into the first noise region may also be determined based on a fact that the current rotational speed of the rear motor Mr falls within the range between the minimum speed and the maximum speed of the first noise region. Likewise, the entrance of the operating point of the front motor Mf into the second noise region may be determined based on a fact that the output torque of the front motor Mf falls within the range between the minimum torque and the maximum torque of the second noise region. Otherwise, the entrance of the operating point of the front motor Mf into the second noise region may also be determined based on a fact that the rotational speed of the front motor Mf falls within the range between the minimum speed and the maximum speed of the second noise region.

lf none of the operating points of the rear motor Mr and the front motor Mf predicted at step S4 is expected to enter the first noise region and the second noise region so that the answer of step S5 is NO, the routine progresses to step S6 to set the torque ratio to the reference torque ratio. Thereafter, the routine returns. By contrast, if at least one of the operating points of the rear motor Mr and the front motor Mf predicted at step S4 is expected to enter the first noise region or the second noise region so that the answer of step S5 is YES, the routine progresses to step S7 to determine whether the vehicle Ve is making a turn. In other words, it is determined at step S7 whether the reference torque ratio is employed to maintain the performance of the vehicle Ve. To this end, at step S7, it may also be determined whether the vehicle Ve is traveling on a rough road such as a rocky road or a slippery road where a coefficient of friction is low.

lf the vehicle Ve is turning so that the answer of step S7 is YES, the routine progresses to the step S8 to set the upper limit value and the lower limit value of the amount of change in the torque ratio by the guard value calculator 25. Specifically, the guard value calculator 25 sets the upper limit value and the lower limit value of the amount of change in the torque ratio to values by which the amount of change in the torque ratio falls within a range where the performance of the vehicle Ve may be maintained or the behavior of the vehicle Ve will not be changed significantly. For example, the upper limit value and the lower limit value of the amount of change in the torque ratio may be set in accordance with a turning radius of the vehicle Ve. In addition, the guard value calculator 25 may be further configured to inhibit the change of the torque ratio depending on the traveling condition of the vehicle Ve. In a case of inhibiting the change of the torque ratio, both of the upper limit value and the lower limit value of the amount of change in the torque distribution ratio are set to zero at step S8. Thereafter, at step S9, the torque ratio is changed by the torque ratio changer 26.

lf the vehicle Ve is not turning so that the answer of step S7 is NO, the routine also progresses to step S9 to change the torque ratio by the torque ratio changer 26. Specifically, the torque ratio changer 26 changes the torque ratio at a predetermined change rate toward the torque ratio by which the operating point of the rear motor Mr falls outside of the first noise region and the operating point of the front motor Mf falls outside of the second noise region. lf the required driving torque varies in this situation, the torque ratio is changed by changing the torque of one of the rear motor Mr and the front motor Mf to achieve the required driving torque while maintaining the torque of other one of the rear motor Mr and the front motor Mf. Thereafter, the routine returns.

This predetermined change rate of the torque ratio is set to a value possible to suppress changes in the behavior and operability of the vehicle Ve to be caused by a sudden change in the torque ratio, based on a result of experimentation or simulation. For example, if it is necessary to change the torque ratio significantly to deviate the operating point of the rear motor Mr and the operating point of the front motor Mf away from the first operation region and the second operation region, it is preferable to start changing the torque ratio at a timing earlier than that in a case of changing the torque ratio slightly. If the upper limit value and the lower limit value of the amount of change in the torque ratio ware set at step S8, the torque ratio is changed within the range between the upper limit value and the lower limit value.

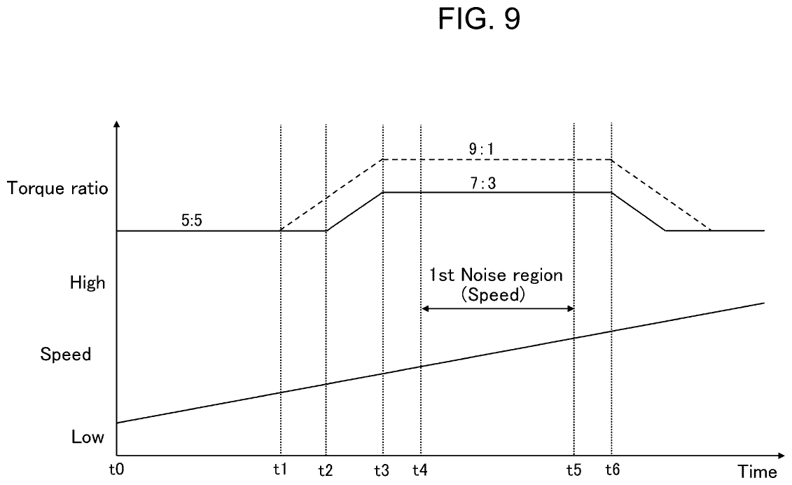

FIG. 9 shows an example to change the torque ratio in such a manner as to prevent the entrance of the operating point of the rear motor Mf into the first operation region and the entrance of the operating point of the front motor Mf into the second operation region when the speed of the vehicle Ve speed is increased in a situation where the required driving torque of the vehicle Ve is constant during propulsion along a straight line. At point to, the torque ratio is set to the reference torque ratio. In this example, the reference torque ratio is set to 5:5. The speed of the vehicle Ve increases gradually from point to, and hence the operating point of e.g., the rear motor Mr is expected to enter the first noise region. In this situation, therefore, the torque ratio is changed at step S9 as explained above.

In FIG. 9, the broken line indicates a case in which the torque ratio for situating the operating point of the rear motor Mr outside of the first noise region is set to 9:1, and the solid line indicates a case in which the torque ratio is set to 7:3. As indicated by the broken line, in the case of changing the torque ratio significantly, the torque ratio starts changing at the predetermined change rate from point t1. Whereas, in the case of changing the torque ratio slightly as indicated by the solid line, the torque ratio starts changing at a predetermined change rate from point t2 which is later than point t1. Thus, in any of those cases, the torque ratio is changed to the torque ratio possible to situate the operating point of the rear motor Mr outside of the first noise region at point t3 before point t4 at which the speed of the rear motor Mr corresponding to the speed of the vehicle Ve reaches the first noise region. Then, at point t5, the speed of the rear motor Mr corresponding to the speed of the vehicle Ve reaches the maximum vehicle speed in the first noise region, and the torque ratio starts changing to the reference torque ratio from point t6 at which the speed of the rear motor Mr is further increased. In the case of changing the torque ratio to the reference torque ratio, it is preferable to change the torque ratio at a predetermined change rate so as to suppress a change in the behavior and operability of the vehicle Ve.

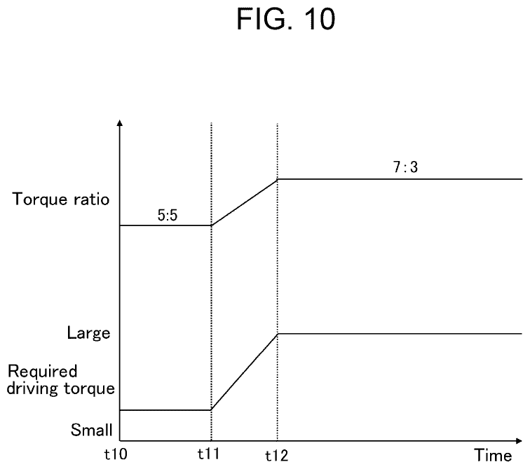

FIG. 10 shows an example to change the torque ratio in such a manner as to prevent the entrance of the operating point of the rear motor Mr into the first noise region when the required driving torque for propelling the vehicle Ve increases. At point t10, the torque ratio is set to the reference torque ratio. In this example, the reference torque ratio is also set to 5:5. When the accelerator pedal is depressed at point t11, the required driving torque starts increasing gradually. Basically, a change rate of the required driving torque is faster than a change rate of the speed of the vehicle Ve. Therefore, a prediction about the entrance of the operating point of the rear motor Mr into the first noise region is made when the required driving torque starts increasing at point t11. Consequently, the torque ratio is changed at step S9 as described above.

Specifically, the torque of the rear motor Mr increases with an increase in the required driving torque, and consequently the operating point of the rear motor Mr will enter the first noise region. Therefore, when the required driving torque increases, the torque of the rear motor Mr is fixed before the operating point of the rear motor Mr enters the first noise region, and the torque ratio is changed by increasing the torque of the front motor Mf. Accordingly, in the example shown in FIG. 10, the torque ratio is changed from point t11 in accordance with the increase in the required driving torque by increasing only the torque of front motor Mf.

At point t12, the required driving torque becomes constant and the torque of the front motor Mf is maintained constant so that the torque ratio is maintained to 7:3.

As described above, according to the embodiment of the present disclosure, the torque ratio is changed from the reference torque ratio when the operating point of the rear motor Mr and the operating point of the front motor Mf are expected to enter the first noise region and the second noise region where noises and vibrations are amplified during operations the motors. Therefore, it is possible to prevent the entrance of the operating points of the rear motor Mr and the front motor Mf into the first noise region and the second noise region while generating the required driving torque to propel the vehicle Ve. As a result, noises and vibrations may be reduced.

In addition, in the case that the reference torque ratio is set to maintain the performance of the vehicle Ve, the upper limit value and the lower limit value of the amount of change in the torque ratio are determined. Therefore, the torque ratio will not be changed significantly to suppress noises and vibrations. Alternatively, a change in the torque ratio may be inhibited in this case. In this case, the performances of the vehicle Ve may be maintained.

In addition, when the required driving torque is changed and the operating points of the rear motor Mr and the front motor Mf are expected to enter the first noise region and the second noise region, the torque of one of the motors is changed in accordance with the change in the required driving torque. Therefore, even if the behavior of the vehicle Ve slightly changes as a result of changing the torque ratio, the driver may not sense the change in the behavior due to the change in the required driving torque and the change in the behavior due to the change in the torque ratio. Therefore, even if the behavior of the vehicle Ve changes by changing the torque ratio, uncomfortable feeling of the driver may be reduced.

The drive force control system for the electric vehicle according to the embodiment of the present disclosure may be further configured to shift the operating mode from the two-wheel drive mode in which the rear motors Mrr and Mlr serve individually as a prime mover to the four-wheel drive mode by activating the front motors Mfr and Mfl, when the operating point of at least any one of the rear motors Mrr and Mlr is/are expected to enter the first noise region during operation in the two-wheel drive mode. For example, when the operating point of at least any one of the rear motors Mrr and Mlr is/are predicted to enter the first noise region in a situation where the reference torque ratio is set to 0:10, the torque ratio may be changed to 3:7.

In the case that the motor generates the regenerative braking torque, noises and vibrations are also amplified at a specific operating point. Therefore, drive force control system according to the embodiment of the present disclosure may be further configured to change the torque ratio when the operating point of the motor is predicted to enter the first noise region or the second noise region in the situation where the regenerative torque is generated by the motor Mrf, Mlf, Mrr, or Mlr during propulsion of the vehicle Ve.

In addition, the electric vehicle according to the embodiment of the present disclosure may also be applied to a hybrid vehicle including a motor as a prime mover for driving one of pairs of front wheels and rear wheels and an engine as a prime mover for driving the other pair of wheels. In this case, the motor torque may also be changed to shift the motor operating point to outside of the noise region when the motor operating point of the motor is expected to enter the noise region. In addition, the torque ratio may be changed by changing the engine torque so as to generate the required driving torque to propel the vehicle. By thus changing the motor torque and the engine torque as described above, it is possible to prevent the entrance of the operating point of the motor into the noise region while maintaining the required driving torque to propel the vehicle. Consequently, abnormal noise and vibration may be reduced.

What is claimed is:

1. A drive force control system for an electric vehicle, comprising:
a motor that drives a first wheel as one of a front wheel and a rear wheel; and
another prime mover that drives a second wheel as other one of the front wheel and the rear wheel,
wherein a four-wheel drive mode in which the electric vehicle is propelled by the motor and the another prime mover is available,
the drive force control system comprises a controller that controls the motor, and
the controller comprises:
a vibration determiner that is configured to determine whether an operating point of the motor governed by an output torque and a speed of the motor will enter a noise region in which noise and vibrations of the motor are amplified during operation of the motor; and
a torque ratio changer that is configured to change a torque ratio as a ratio between a torque driving the first wheel and a torque driving the second wheel from a reference torque ratio so as to deviate the operating point of the motor from the noise region, when the vibration determiner determines that the operating point of the motor will enter the noise region.

2. The drive force control system for the electric vehicle as claimed in claim 1, wherein the controller further comprises a guard value calculator that calculates an upper limit value and a lower limit value of an amount of change in the torque ratio, and
the guard value calculator is configured to set the upper limit value and the lower limit value in a case that the reference torque ratio is employed to maintain a performance of the electric vehicle.

3. The drive force control system for the electric vehicle as claimed in claim 1, wherein the torque ratio changer is further configured to start changing the torque ratio at an earlier timing when changing the torque ratio significantly.

4. The drive force control system for the electric vehicle as claimed in claim 1, wherein the torque ratio changer is further configured to change a torque of the another prime mover with a change in a required driving torque to propel the electric vehicle while maintaining an output torque of the motor to the torque before the operating point of the motor enters the noise region, when the vibration determiner determines that the operating point of the motor will enter the noise region due to a change in the output torque of the motor.
